(19) United States
(12) Patent Application Publication
(10) Pub. No.: US 2015/0074166 A1
(43) Pub. Date: Mar. 12, 2015

(54) METHOD AND APPARATUS FOR PROCESSING MULTI-LAYER DATA

(71) Applicant: Electronics and Telecommunications Research Institute, Daejeon (KR)

(72) Inventors: Jung Hee LEE, Daejeon (KR); Bhum Cheol LEE, Daejeon (KR); Young Ho PARK, Daejeon (KR); Sang-Min LEE, Daejeon (KR); Kang Il CHOI, Daejeon (KR); Seung-Woo LEE, Daejeon (KR)

(73) Assignee: Electronics and Telecommunications Research Institute, Daejeon (KR)

(21) Appl. No.: 14/247,500

(22) Filed: Apr. 8, 2014

(30) Foreign Application Priority Data
Sep. 11, 2013 (KR) 10-2013-0108955

(51) Int. Cl. H04L 29/06

(52) U.S. Cl. CPC H04L 69/14
USPC 709/201

(57) ABSTRACT

An apparatus for processing multi-layer data, the apparatus comprising: a lower layer switch configured to classify lower layer data based on frame or packet from multi-layer data having different properties for switching processing; and an upper layer switch configured to generate flows of the multi-layer data having different properties based on upper layer information or lower layer information.

### RELATED APPLICATIONS

This application claims the benefit of Korean Patent Application No. 10-2013-0108955, filed on Sep. 11, 2013, which is hereby incorporated by reference as if fully set forth herein.

### FIELD OF THE INVENTION

The present invention relates to a distributed parallel processing to perform a multi-layer parallel processing on incoming data by dividing the data on a layer basis, and more particularly, to a multi-layer data processing that is adapted for effectively carrying out a distributed parallel processing and a switching when simultaneously performing a multi-layer processing on the data that are made up full layers from Layer 1 to Layer 7 or some layers of the full layers.

### BACKGROUND OF THE INVENTION

Multi-layer switching depends on processing performance; therefore, multi-processors need to improve the processing performance.

A multi-processor not only has a merit in terms of data processing performance and power consumption, but also has an advantage to install various programs to implement their corresponding functions. Accordingly, it is expected that the multi-processor will be widely utilized in the fields of terminals, home appliances, communications, broadcasts and the like.

A number of multi-processors are employed in order to improve multi-layer processing performance. When performing a parallel processing in a multi-processor environment, the order of the data flow that has been processed must be maintained. One of related-arts that the order of data flow is maintained while improving processing performance is disclosed in U.S. Pat. No. 6,854,117, entitled, “Parallel Processor Network Array.” This related-art minutely classifies data flows that are input (using the information of layer 2 to layer 4) and allocates the same flows to the same processor core when the flows are processed by the processor core, thereby maintaining the order of the flows while improving the processing performance. However, since the related-art employs a multi-processor having one array to perform a multi-layer processing on multi-layer data having different attributes for each layer, it cannot achieve a scalable increase in the processing performance and cannot use other processors having different array structures along with the multi-processor having one array.

Another approach to handle the multi-layer data is to divide entire layers, for example, seven layers, into groups, each group having two or three layers, and individually process the respective groups. A Layer 2-4 processor, which is used to process data in a layer 2 to a layer 4, mainly processes frames or packets using dedicated hardware or network processors. A main issue of the Layer 2-4 processor is its processing performance. A Layer 7 processor is used in an application layer on which the content of various services is installed. The Layer 7 processor processes the services in software using general-purpose processors. Its main issue is flexibility.

U.S. Pat. No. 7,551,617, entitled “Multi-threaded packet processing architecture with global packet memory, packet recirculation, and coprocessor,” discloses a technology to increase a packet processing capacity and throughput by additionally incorporating recirculation interfaces besides exterior interfaces.

However, since the layer that is treated by an exterior interface and the layer that is processed by a recirculation interface is the same, parallel processing efficiency may be deteriorated in multi-layer processing. Also, the exterior interface has the same parallel processing structure as the recirculation interface. As a result, parallelism in the multi-layer processing may be less.

### SUMMARY OF THE INVENTION

In view of the above, the present invention provides an apparatus and method of processing multi-layer data that are adapted to constitute a processor array capable of processing the multi-layer data on a layer basis to improve processing performance.

Further, the present invention provides an apparatus and method of processing multi-layer data that are adapted to classify multi-layer data into groups on a layer basis and perform a parallel processing of the respective groups, thereby resolving the degradation of parallel processing efficiency due to repeated treatment of the same layers.

Further, the present invention provides an apparatus and method of processing multi-layer data that are adapted to generate flows so that the data group for each layer can interwork and perform a multi-layer processing and switching, thereby resolving performance degradation and synchronization issues caused by multi-layer processing.

In accordance with an embodiment of the present invention, there is provided an apparatus for processing multi-layer data, which includes: a lower layer switch configured to classify lower layer data based on frame or packet from multi-layer data having different properties for switching processing; and an upper layer switch configured to generate flows of the multi-layer data having different properties based on upper layer information or lower layer information.

In the embodiment, wherein the upper layer switch is configured to perform an upper layer switching on the flows in parallel.

In the embodiment, wherein the upper layer switch is configured to interwork with data that are switched through the lower layer switch.

In the embodiment, wherein the lower layer switch and the upper layer switch are configured to perform in a parallel fashion.

In the embodiment, wherein the lower layer switch comprises a Layer 2 switch.

In the embodiment, wherein the upper layer switch comprises a Layer 4-7 switch from Layer 4 to Layer 7.

In the embodiment, wherein the lower layer switch includes: a classifier configured to receive the multi-layer data, which is input from an external network via one or more ports, looks up the lower layer information to be assigned one or more ports to switch, and classify the multi-layer data based on the lower layer information; a switching unit connected to the classifier and configured to switch the multi-layer data in a unit of frame, packet or flow; and a lower layer table configured to contain the lower layer information and connected to the classifier and the switching unit.

In the embodiment, wherein the lower layer information comprises a list corresponding to the lower layer data and an operation list of the lower layer data.

In the embodiment, wherein the upper layer switch comprises: a flow generation unit configured to receive the multi-layer data, which is input via one or more ports of the lower layer switch, and generate the flows based on lower layer information or upper layer information; a switching processor configured to perform the upper layer switching and processing on the flows, which are generated by the flow generation unit; an upper layer table connected to the flow generation unit and the switching processor and configured to contain a list corresponding to upper layer data and an operation list of the upper layer data; and a lower layer interworking table connected to the upper layer table and configured to contain a list and an operation list for interworking with the upper layer switch.

In the embodiment, wherein the lower layer interworking table is used to interwork the lower layer table in the lower layer switch with the upper layer table in the upper layer switch.

In the embodiment, wherein the lower layer interworking table allows the lower layer table of the lower layer switch to synchronize with the upper layer table of the upper layer switch.

In accordance with an embodiment of the present invention, there is provided a method for processing multi-layer data, which includes: when multi-layer data is input from external networks, look up lower layer information in a lower layer table of a lower layer switch and classifying the multi-layer data based on the lower layer information; in the case of a lower layer switching, switching the multi-layer data that have been subjected to the lookup and classification to one or more port of the lower layer switch to output the multi-layer data; in case of an upper layer switching, generating flows of the multi-layer data that have been subjected to the lookup and classification in an upper layer switch based on upper layer information in an upper layer table of the upper layer switch; and when generating the flows, performing an upper layer processing and an upper layer switching on the flows in parallel.

In the embodiment, the method further comprising: after performing an upper layer processing and an upper layer switching in parallel, interworking with the lower layer switch based on the upper layer information corresponding to the information in a lower layer interworking table.

As explained above, the embodiment of the present invention performs a flow based-parallel processing and switching on the data having multi-layer structure on a layer basis and thus has merits as follows.

First, it is possible to achieve an efficient layer processing and switching by processing multi-layer data on a basis of frame or packet in a lower layer and producing flows to process them in parallel in an upper layer. Second, it is possible to maintain the utilization of existing lower layer equipments by classifying the multi-layer data according to layers having different properties and processing the classified upper layer data in parallel based on the property to interwork with the lower layer. Accordingly, third, it is possible to share tasks in both the lower and upper layers for processing the tasks pursuant to functionality and performance.

### BRIEF DESCRIPTION OF THE DRAWINGS

The above and other objects and features of the present invention will become apparent from the following description of the embodiments given in conjunction with the accompanying drawings, in which:

FIG. 1 is an entire block diagram of an apparatus for processing multi-layer data in accordance with an embodiment of the present invention;

FIG. 2 is a detailed block diagram of the lower layer switch and the upper layer switch of the multi-layer data processing apparatus shown in FIG. 1;

FIG. 3 is an example of the lower layer switch and the upper layer switch of the multi-layer data processing apparatus in accordance with an embodiment of the present invention; and

FIG. 4 is a flowchart illustrating a method for processing multi-layer data in accordance with an embodiment of the present invention.

### DETAILED DESCRIPTION OF THE EMBODIMENTS

The advantages and features of exemplary embodiments of the present invention and methods of accomplishing them will be clearly understood from the following description of the embodiments taken in conjunction with the accompanying drawings. However, the present invention is not limited to those embodiments and may be implemented in various forms. It should be noted that the embodiments are provided to make a full disclosure and also to allow those skilled in the art to know the full scope of the present invention. Therefore, the present invention will be defined only by the scope of the appended claims. Similar reference numerals refer to the same or similar elements throughout the drawings.

In the following description, well-known functions or constitutions will not be described in detail if they would unnecessarily obscure the embodiments of the invention. Further, the terminologies to be described below are defined in consideration of functions in the invention and may vary depending on a user's or operator's intention or practice. Accordingly, the definition may be made on a basis of the content throughout the specification.

The combinations of the each block of the block diagram and each operation of the flow chart may be performed by computer program instructions. Because the computer program instructions may be loaded on a general purpose computer, a special purpose computer, or a processor of programmable data processing equipment, the instructions performed through the computer or the processor of the programmable data processing equipment may generate the means performing functions described in the each block of the block diagram and each operation of the flow chart. Because the computer program instructions may be stored in a computer usable memory or computer readable memory which is capable of intending to a computer or other programmable data processing equipment in order to embody a function in a specific way, the instructions stored in the computer usable memory or computer readable memory may produce a manufactured item involving the instruction means performing functions described in the each block of the block diagram and each operation of the flow chart. Because the computer program instructions may be loaded on the computer or other programmable data processing equipment, the instructions performed by the computer or programmable data processing equipment may provide the operations for executing the functions described in the each block of the block diagram and each operation of the flow chart by a series of functional operations being performed on the computer or programmable data processing equipment, thereby a process executed by a computer being generated.

Moreover, the respective blocks or the respective sequences in the appended drawings may indicate modules, segments, or some of codes including at least one executable instruction for executing a specific logical function(s). In several alternative embodiments, it is noticed that the functions described in the blocks or the sequences may run out of order. For example, two successive blocks and sequences may be substantially executed simultaneously or often in reverse order according to corresponding functions.

Hereinafter, the embodiments of the present invention will be described in detail with reference to the accompanying drawings.

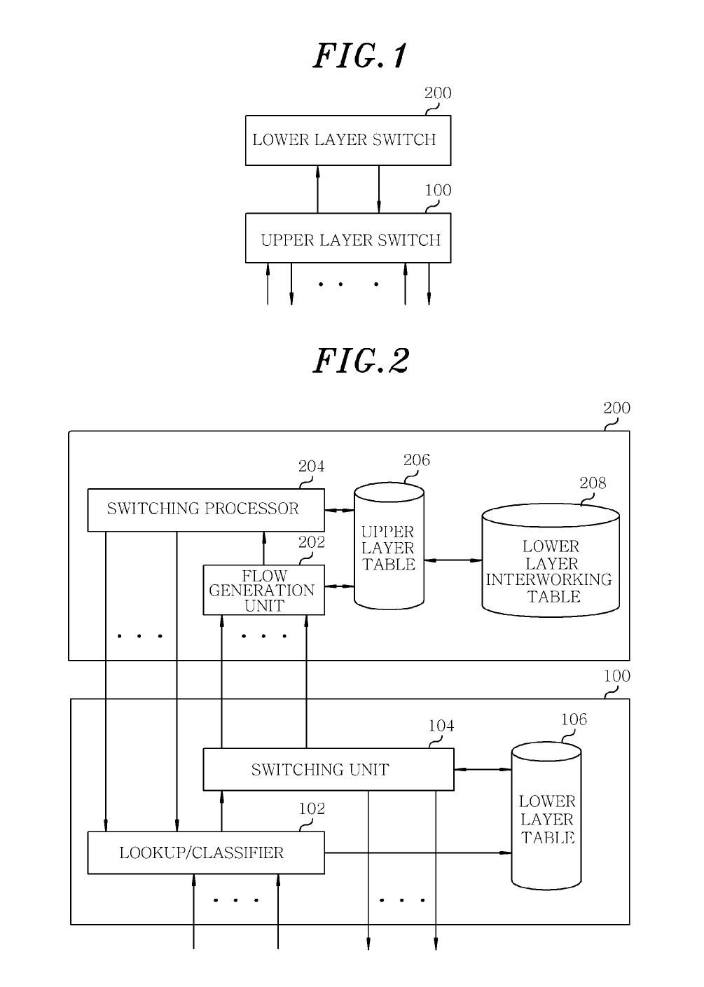

FIG. 1 is an entire block diagram of an apparatus for processing multi-layer data in accordance with an embodiment of the present invention.

The apparatus of the embodiment includes a lower layer switch 100 and an upper layer switch 200 for integrally processing multi-layer data from Layer 2 to Layer 7.

Referring to FIG. 1, the lower layer switch 100 receives a plurality of multi-layer data that are input from an exterior such as external networks, external terminals, or the like and performs a switching processing so that lower layer data among the multi-layer data are send back to the external networks or the multi-layer data are provided to the upper layer switch 200.

The upper layer switch 200 processes the multi-layer data that are provided from the lower layer switch 100 using upper layer data and then provides the processed multi-layer data back to the lower layer switch 100.

More specifically, the lower layer switch 100 performs a switching operation based on lower layer information. That is, the lower layer switch 100 provides the multi-layer data that should be processed by the upper layer switch 200 to the upper layer switch 200 and interworks with the upper layer switch 200 to process the multi-layer data that are processed in the upper layer switch 200.

The upper layer switch 200 generates flows of the multi-layer data through the use of lower layer information and upper layer information and performs the functions allocated to the upper layer on the flows in parallel. In this regard, the upper layer switch 200 processes the multi-layer data and then provides the result so processed to the lower layer switch 100 so that the result processed in the upper layer can interwork with data classified by the lower layer and then provides the processed result of the upper layer to the lower layer switch 100 so as to perform the switching.

FIG. 2 is a detailed block diagram of the lower layer switch 100 and the upper layer switch 200 of the multi-layer data processing apparatus shown in FIG. 1. The embodiment of the present invention will be described in detail with reference to the block diagram of FIG. 2.

Referring to FIG. 2, the lower layer switch 100 includes a lookup/classifier 102, a switching unit 104 and a lower layer table 106.

The lookup/classifier 102 receives the multi-layer data that are input from the external networks via one or more ports and looks up lower layer information in the lower layer table 106 so as to be assigned port(s) to switch in the switching unit 104 or to classify the multi-layer data using the lower layer information.

The switching unit 104 is connected to the lookup/classifier 102 and serves to switch the multi-layer data in a unit of frame, packet or flow to the upper layer switch 200.

The lower layer table 106 includes the lower layer information, for example, a list corresponding to the lower layer data, an operation list of the lower layer data, etc. and is connected to the lookup/classifier 102 and the switching unit 104 to interwork the list and the operation list with the upper layer.

Meanwhile, the upper layer switch 200 includes a flow generation unit 202, a switch processor 204, upper layer table 206, and lower layer interworking table 208.

The flow generation unit 202 receives the multi-layer data that are input via one or more ports in the lower layer switch 100 and generates flows of the multi-layer data by the use of lower layer information and/or upper layer information.

The switching processor 204 performs a switching operation (i.e., a parallel switching operation) on the flows that are generated by the flow generation unit 202 in parallel or performs an upper layer switching operation (i.e., load balancing) on the flows.

The upper layer table 206 is connected to the flow generation unit 202 and the switching processor 204 and includes a list corresponding to the upper layer data, an operation list of the upper layer data, and the like.

The lower layer interworking table 208 is connected to the upper layer table 206 and includes a list and an operation list for interworking with the upper layer switch 100.

The lower layer interworking table 208 is used to interwork the lower layer table 106 in the lower layer switch 100 with the upper layer table 206 in the upper layer switch 200. The lower layer interworking table 208 may be configured on the same system or may be separately configured on different systems.

The lower layer table 106 in the lower layer switch 100 and the upper layer table 206 in the upper layer switch 200 should be synchronized with each other so that the result processed by the upper layer switch 200 interworks with the lower layer switch 100.

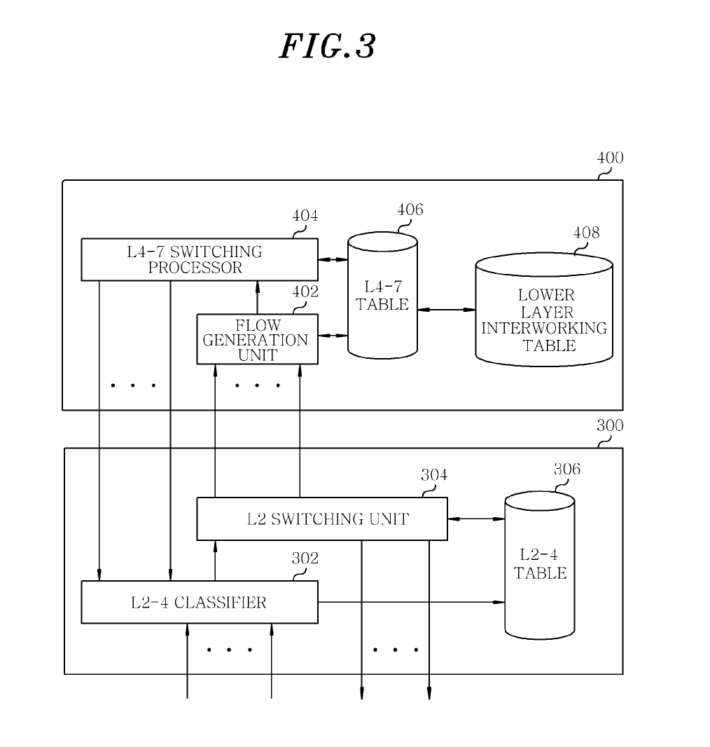

FIG. 3 illustrates an example of the lower layer switch and the upper layer switch of the multi-layer data processing apparatus in accordance with an embodiment of the present invention. Hereinafter, the lower layer switch will be referred to as a Layer 2 (abbreviated to “L2”) switch 300 and the upper layer switch will be referred to as a Layer 4-7 (abbreviated to “L4-7”) switch 400.

Referring to FIG. 3, the L2 switch 300 includes a layer 2-4 (hereinafter, “L2-4”) classifier 302, an L2 switching unit 304 and an L2-4 table 306.

The L2-4 classifier 302 receives L2 frames, e.g., Ethernet frames, via port(s) of the L2 switch 300 and classifies the received frames using L2-4 information contained in the received frames.

The L2 switching unit 304 sends the received frames to the exterior of the L2 switch 300 or the L4-7 switch 400 based on the frame information classified by the L2-4 classifier 302 and information in the L2-4 table 306 that will be explained later.

The L2-4 table 306 is connected to both the L2-4 classifier 302 and the L2 switch 304 and includes a classification corresponding to L2-4 information of the frames, an operation list of the frames such as forwarding, and so on.

Meanwhile, the L4-7 switch 400 includes a flow generation unit 402, an L4-7 switching processor 404, an L4-7 table 406, and a lower layer interworking table 408.

The flow generation unit 402 generates flows of the frames input from the L2 switch 300 using L2-4 information about the frames and/or L4-7 information.

The L4-7 switching processor 404 performs an L4-7 switching and an L4-7 processing in parallel on the flows that are generated by the flow generation unit 402.

The L4-7 table is connected to the flow generation unit 402, and the L4-7 switching processor 404 and has a forwarding/routing table listing, a classification operation list, a searching operation list, and the like that correspond to L2-4 information of the received frames and/or L4-7 information.

The lower layer interworking table 408 is connected to the L4-7 table 406 and has a lookup table list that enables to interwork with the lower layer.

In FIG. 3, it may be possible to configure either a single L2 switch 300 or plural L2 switches 300. In the case of plural L2 switches 300, the L4-7 switch 400 connected to the plural L2 switches 300 may carry out an L2 switch fabric function. That is, the L4-7 switch 400 may be implemented to switch between different L2 switches.

Further, in FIG. 3, when the DPI (Deep Packet Inspection) is carried out in the L4-7 switch 400, the L4-7 switching processor 404 of the L4-7 switch 400 is configured to perform the DPI based on L2-7 information about the frames or L4-7 information in the L4-7 table 406, thereby controlling the frames.

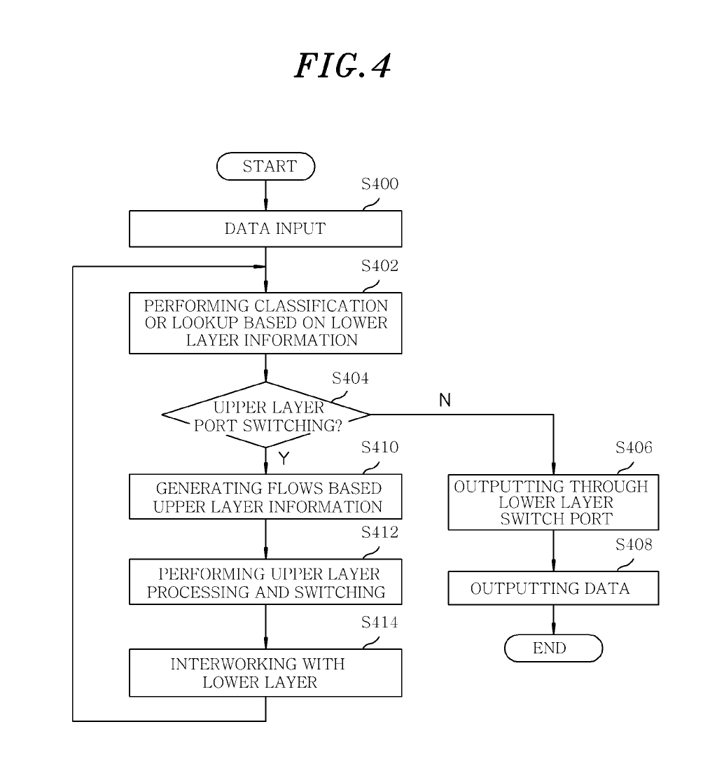

A method for processing multi-layer data of the embodiment of the present invention will be described with reference to a flowchart of FIG. 4 along with the configuration as set forth above.

Referring to FIG. 4, when multi-layer data is received through the lower layer switch 100 from external networks in Block 5400, the lower layer switch 100 looks up the lower layer table 106 and classifies the multi-layer data based on lower layer information in the lower layer table 106 in Block 5402.

Next, the lower layer switch 100 determines whether to switch the multi-layer data, which has been subjected to the lookup and classification, to either a line direction (a downward direction) or the upper layer switch 200 in Block 5404.

When it is determined to switch to the downward direction in Block 5404, the multi-layer data, which has been subjected to the lookup and classification, is supplied to the lower layer switch 100 in Block 5406 and then is output via one or more ports of the lower layer switch 100 to the exterior in Block 5408.

Meanwhile, when it is determined to switch to the upper layer switch in Block 5404, the multi-layer data, which has been subjected to the lookup and classification, is supplied to the upper layer switch 200. The upper layer switch 200 then generates flows based on upper layer information in the upper layer table 206 in Block 5410.

After generating the flows, the upper layer switch 200 performs an upper layer processing and an upper layer switching in parallel on the flows in Block 5412.

Further, the upper layer switch 200 interworks with the lower layer switch 100 based on the upper layer information corresponding to the information in the lower layer table 106 in order to interlink with the lower layer in Block 5414. After performing the interworking with the lower layer, the upper layer switch 200 switches the multi-layer data back to the lower layer switch 100 in Block 5402 where the above described operations are repeated.

As explained above, the embodiment of the present invention implements an efficient layer processing and switching by processing multi-layer data on a basis of frame or packet in a lower layer switch and producing flows to process them in parallel in an upper layer. Further, the embodiment classifies the multi-layer data according to layers having different property and processes the classified upper layer data in parallel based on the property to interwork with the lower layer data. Accordingly, it is possible not only to maintain the utilization of existing lower layer equipments, but also to share tasks in both the lower and upper layers for processing the tasks pursuant to functionality and performance.

While the invention has been shown and described with respect to the embodiments, the present invention is not limited thereto. It will be understood by those skilled in the art that various changes and modifications may be made without departing from the scope of the invention as defined in the following claims.

What is claimed is:

1. An apparatus for processing multi-layer data, the apparatus comprising:
a lower layer switch configured to classify lower layer data based on frame or packet from multi-layer data having different properties for switching processing; and
an upper layer switch configured to generate flows of the multi-layer data having different properties based on upper layer information or lower layer information.

2. The apparatus of claim 1, wherein the upper layer switch is configured to perform an upper layer switching on the flows in parallel.

3. The apparatus of claim 1, wherein the upper layer switch is configured to interwork with data that are switched through the lower layer switch.

4. The apparatus of claim 1, wherein the lower layer switch and the upper layer switch are configured to perform in a parallel fashion.

5. The apparatus of claim 1, wherein the lower layer switch comprises a Layer 2 switch.

6. The apparatus of claim 1, wherein the upper layer switch comprises a Layer 4-7 switch from Layer 4 to Layer 7.

7. The apparatus of claim 1, wherein the lower layer switch includes:
a classifier configured to receive the multi-layer data, which is input from an external network via one or more ports, looks up the lower layer information to be assigned one or more ports to switch, and classify the multi-layer data based on the lower layer information;
a switching unit connected to the classifier and configured to switch the multi-layer data in a unit of frame, packet or flow; and
a lower layer table configured to contain the lower layer information and connected to the classifier and the switching unit.

8. The apparatus of claim 7, wherein the lower layer information comprises a list corresponding to the lower layer data and an operation list of the lower layer data.

9. The apparatus of claim 1, wherein the upper layer switch comprises:
a flow generation unit configured to receive the multi-layer data, which is input via one or more ports of the lower layer switch, and generate the flows based on lower layer information or upper layer information;
a switching processor configured to perform the upper layer switching and processing on the flows, which are generated by the flow generation unit;
an upper layer table connected to the flow generation unit and the switching processor and configured to contain a list corresponding to upper layer data and an operation list of the upper layer data; and
a lower layer interworking table connected to the upper layer table and configured to contain a list and an operation list for interworking with the upper layer switch.

10. The apparatus of claim 9, wherein the lower layer interworking table is used to interwork the lower layer table in the lower layer switch with the upper layer table in the upper layer switch.

11. The apparatus of claim 9, wherein the lower layer interworking table allows the lower layer table of the lower layer switch to synchronize with the upper layer table of the upper layer switch.

12. A method for processing multi-layer data, the method comprising:
when multi-layer data is input from external networks, look up lower layer information in a lower layer table of a lower layer switch and classifying the multi-layer data based on the lower layer information;
in the case of a lower layer switching, switching the multi-layer data that have been subjected to the lookup and classification to one or more port of the lower layer switch to output the multi-layer data;
in case of an upper layer switching, generating flows of the multi-layer data that have been subjected to the lookup and classification in an upper layer switch based on upper layer information in an upper layer table of the upper layer switch; and
when generating the flows, performing an upper layer processing and an upper layer switching on the flows in parallel.

13. The method of claim 12, further comprising:
after performing an upper layer processing and an upper layer switching in parallel, interworking with the lower layer switch based on the upper layer information corresponding to the information in a lower layer interworking table.
